(19) United States
(12) Patent Application Publication
(10) Pub. No.: US 2026/0059438 A1
(43) Pub. Date: Feb. 26, 2026

(54) ELECTRONIC DEVICE FOR SUPPORTING NON-TERRESTRIAL NETWORK COMMUNICATION AND OPERATING METHOD THEREOF

(71) Applicant: SAMSUNG ELECTRONICS CO., LTD., Suwon-si (KR)

(72) Inventors: Keonyoung LEE, Suwon-si (KR); Myungkil KANG, Suwon-si (KR); Donghyeon KIM, Suwon-si (KR)

(73) Assignee: SAMSUNG ELECTRONICS CO., LTD., Suwon-si (KR)

(21) Appl. No.: 19/305,469

(22) Filed: Aug. 20, 2025

Related U.S. Application Data
(63) Continuation of application No. PCT/KR2025/011685, filed on Aug. 5, 2025.

(30) Foreign Application Priority Data
Aug. 20, 2024 (KR) 10-2024-0111159
Oct. 8, 2024 (KR) 10-2024-0136713
Oct. 17, 2024 (KR) 10-2024-0142191

(51) Int. Cl. H04W 48/20

(52) U.S. Cl. CPC H04W 48/20

(57) ABSTRACT

An electronic device may include: memory storing instructions that, when executed by at least one processor, cause the electronic device to: identify satisfaction of a condition indicating that the non-terrestrial network is not used for at least a specified period of time, obtain a search result for at least one public land mobile network (PLMN) of a terrestrial network by requesting a search for the at least one PLMN of the terrestrial network from the at least one communication module, select a first PLMN from the at least one PLMN of the terrestrial network; request an access to the first PLMN from the at least one communication module, and control the at least one communication module to, based on the request for the access to the first PLMN, perform at least one operation for the access using a cell of the first PLMN.

### CROSS-REFERENCE TO RELATED APPLICATIONS

This application is a continuation application of International Application No. PCT/KR2025/011685, filed on Aug. 5, 2025, which is based on and claims priority from Korean Patent Application No. 10-2024-0111159, filed on Aug. 20, 2024, Korean Patent Application No. 10-2024-0136713, filed on Oct. 8, 2024, and Korean Patent Application No. 10-2024-0142191, filed on Oct. 17, 2024, the disclosures of which are herein incorporated by reference in their entireties.

### BACKGROUND

### 1. Field

The disclosure relates to an electronic device for supporting a non-terrestrial network communication and an operating method thereof.

### 2. Description of Related Art

Recently, an electronic device supporting a non-terrestrial network communication (e.g., a satellite communication) has been actively introduced. For example, the electronic device may communicate with a satellite of an existing satellite communication company using a frequency and a communication scheme of the company. For example, the electronic device may communicate with a satellite by using a cellular frequency according to a long-term evolution (LTE) standard (or, a 5G standard) based on the LTE standard. For example, the electronic device may also communicate with a satellite based on a 5G non-terrestrial networks (NTN) standard.

For example, if the electronic device performs a communication with a non-terrestrial network based on the LTE standard, some of frequencies defined in the LTE standard may be allocated to the non-terrestrial communication. The electronic device may perform a satellite communication using a protocol stack used in a terrestrial communication, and an additional protocol stack for the non-terrestrial communication may not be required. The electronic device may perform a communication without distinguishing between the non-terrestrial communication and the terrestrial communication. For example, the electronic device may perform a cell scan, camp on a cell which satisfies cell selection criteria, and perform an operation for accessing a network (for example, the operation for accessing the network may include a camp on, a random access (RA) procedure, a connection establishment procedure, and/or an attach (or registration) procedure). The electronic device may perform an operation for camping on a cell which satisfies cell selection criteria and accessing a network without distinguishing between the non-terrestrial communication and the terrestrial communication. Accordingly, in substantially the same manner as the terrestrial communication, the electronic device may prepare for performing the non-terrestrial communication.

### SUMMARY

According to an aspect of the disclosure, an electronic device may include: at least one processor including processing circuitry; at least one communication module including communication circuitry; and memory storing instructions, wherein the instructions, when executed by the at least one processor individually or collectively, cause the electronic device to: after the electronic device accesses a non-terrestrial network using the at least one communication module, identify satisfaction of a condition indicating that the non-terrestrial network is not used for at least specified period of time based on the satisfaction of the condition, obtain a search result for at least one public land mobile network (PLMN) of a terrestrial network by requesting a search for the at least one PLMN of the terrestrial network from the at least one communication module, wherein the at least one communication module is configured to provide the at least one processor with the search result for the at least one PLMN of the terrestrial network based on the requesting the search, select a first PLMN from the at least one PLMN of the terrestrial network identified based on the search result, request an access to the first PLMN from the at least one communication module, and control the at least one communication module to, based on the request for the access to the first PLMN, perform at least one operation for the access using a cell of the first PLMN.

According to an aspect of the disclosure, an operating method of an electronic device including at least one processor including processing circuitry and at least one communication module including communication circuitry, may include: accessing, by the at least one communication module, a non-terrestrial network; identifying, by the at least one processor, satisfaction of a condition indicating that the non-terrestrial network is not used for at least a specified period of time, after accessing the non-terrestrial network; based on the satisfaction of the condition, requesting, by the at least one processor, a search for at least one public land mobile network (PLMN) of a terrestrial network from the at least one communication module; providing, by the at least one communication module, the at least one processor with a search result for the at least one PLMN of the terrestrial network based on the requesting the search; obtaining, by the at least one processor, the search result; selecting, by the at least one processor, a first PLMN from the at least one PLMN of the terrestrial network identified based on the search result; requesting, by the at least one processor, an access to the first PLMN from the at least one communication module; and performing, by the at least one communication module, at least one operation for the access using a cell of the first PLMN, based on the requesting for the access to the first PLMN.

According to an aspect of the disclosure, a non-transitory computer-readable storage medium stores instructions that, when executed by at least one processor including processing circuitry of an electronic device, individually or collectively, may cause the electronic device to: identify satisfaction of a condition indicating that a non-terrestrial network is not used for at least a specified period of time, after the electronic device accesses the non-terrestrial network using at least one communication module; based on the satisfaction of the condition, obtain a search result for a public land mobile network (PLMN) of a terrestrial network; select a first PLMN from at least one PLMN of the terrestrial network which is identified based on the search result for the PLMN of the terrestrial network; and perform at least one operation for an access using a cell of the first PLMN.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a block diagram illustrating an electronic device within a network environment according to one or more embodiments;

FIG. 2 is a diagram illustrating an electronic device and a long-range communication network environment according to one or more embodiments;

FIG. 3 is a diagram for describing an access of an electronic device according to one or more embodiments;

FIG. 4 is a diagram for describing a non-terrestrial network system according to one or more embodiments;

FIG. 5 is a drawing for describing an electronic device according to an one or

more embodiments;

FIG. 6 is a drawing for describing an electronic device according to a comparative example for comparison with one or more embodiments;

FIG. 7 is a drawing for describing an operating method of an electronic device according to one or more embodiments;

FIG. 8 is a drawing for describing an operating method of an electronic device according to one or more embodiments;

FIG. 9 is a drawing for describing an operating method of an electronic device according to one or more embodiments;

FIG. 10 is a drawing for describing an operating method of an electronic device according to one or more embodiments;

FIG. 11 is a drawing for describing a user interface provided by an electronic device according to one or more embodiments;

FIG. 12 is a drawing for describing an operating method of an electronic device according to one or more embodiments;

FIG. 13 is a drawing for describing a screen provided by an electronic device according to one or more embodiments;

FIG. 14 is a drawing for describing an operating method of an electronic device according to one or more embodiments;

FIG. 15 is a drawing for describing a screen provided by an electronic device according to one or more embodiments; and

FIG. 16 is a drawing for describing an operating method of an electronic device according to one or more embodiments.

### DETAILED DESCRIPTION

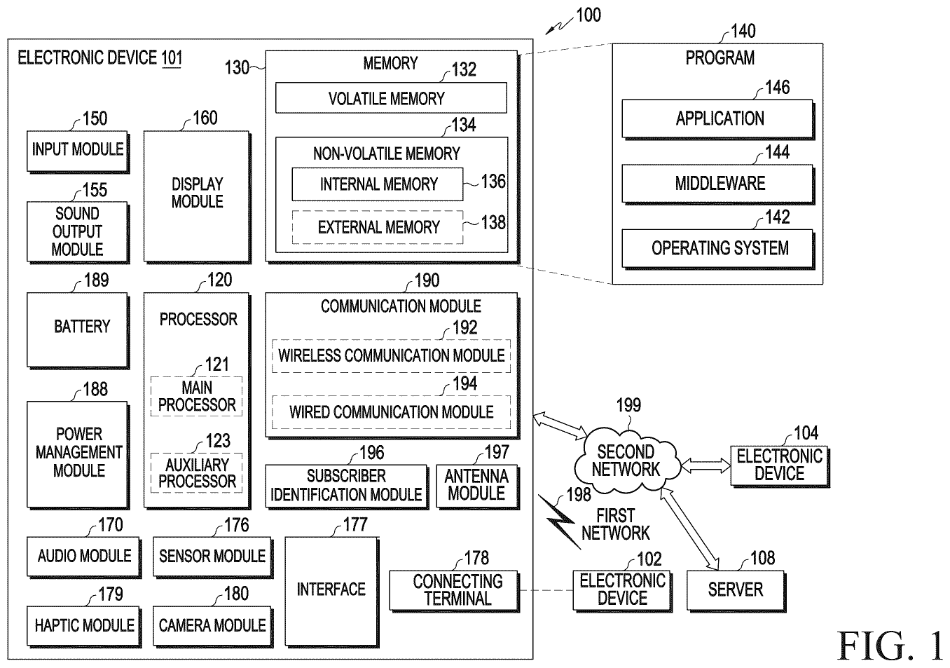

FIG. 1 is a block diagram illustrating an electronic device 101 in a network environment 100 according to an embodiment.

Referring to FIG. 1, the electronic device 101 in the network environment 100 may communicate with an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control, for example, at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active (e.g., executing an application) state. According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may acquire the sound via the input module 150, or output the sound via the sound output module 155 or an external electronic device (e.g., an electronic device 102 (e.g., a speaker or a headphone)) directly or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device 104 via the first network 198 (e.g., a short-range communication network, such as Bluetooth™, wireless fidelity (WiFi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify or authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 from the plurality of antennas. The signal or the power may then be transmitted or received between the communication module 190 and the external electronic device via the selected at least one antenna. According to some embodiments, another component (e.g., a radio frequency integrated circuit (RFIC)) other than the radiating element may be additionally formed as part of the antenna module 197.

According to an embodiment, the antenna module 197 may form a mmWave antenna module. According to an embodiment, the mmWave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

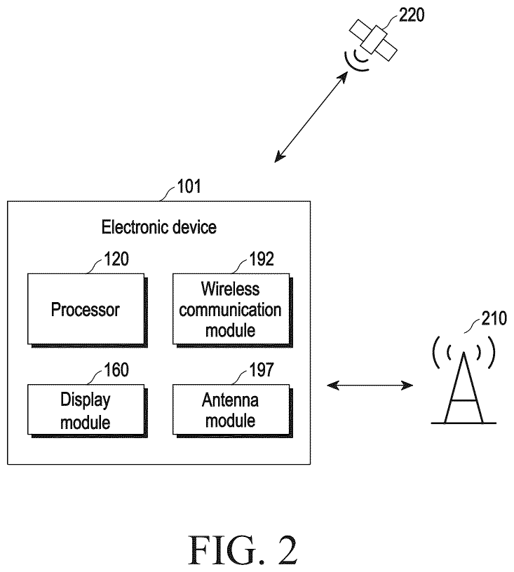

FIG. 2 is a diagram illustrating an electronic device and a long-range communication network environment according to one or more embodiments.

An electronic device 101 may transmit and/or receive data via a terrestrial network and/or a non-terrestrial network. The electronic device 101 may have the same as the configuration of the electronic device 101 illustrated in FIG. 1 or may include the configuration of the electronic device 101 illustrated in FIG. 1.

The terrestrial network may refer to a network capable of providing a data communication via a terrestrial wireless communication device 210. For example, the terrestrial wireless communication device 210 may include a base station located on the ground (e.g., fixed to the ground). The terrestrial wireless communication device 210 may support at least one of various communication schemes supportable by the electronic device 101. For example, the terrestrial wireless communication device 210 may include an eNodeB (e.g., an LTE-based base station) or a gNodeB (e.g., a 5G (or NR)-based base station), but is not limited thereto.

The non-terrestrial network may refer to a network capable of providing a data communication via at least one non-terrestrial wireless communication device 220. For example, the non-terrestrial wireless communication device 220 may include at least one of various communication devices such as a base station and a repeater which are not located on the ground. For example, the non-terrestrial wireless communication device 220 may include a satellite and/or an unmanned aerial vehicle, but is not limited thereto. For example, the satellite may include a low-earth orbit (LEO) satellite, a medium-earth orbit (MEO) satellite, a geostationary earth orbit (GEO) satellite, and/or a high elliptical orbit (HEO) satellite. For example, the satellite may include an orbiting satellite and/or a geostationary satellite.

The non-terrestrial wireless communication device 220 may support at least one of various wireless communication schemes. For example, the non-terrestrial wireless communication device 220 may support an NR non-terrestrial network (NTN) defined by 3rd generation partnership project (3GPP). Alternatively, the non-terrestrial wireless communication device 220 may support at least one of communication schemes based on various communication standards such as LTE, global system for mobile communications (GSM), or code-division multiple access (CDMA), but is not limited thereto.

The terrestrial network and the non-terrestrial network may be networks independent of each other. Alternatively, the terrestrial network and the non-terrestrial network may be included in at least one network (e.g., a network provided by the same provider) associated with each other.

If a communication with the terrestrial network is not possible or is not seamless, the electronic device 101 may perform a wireless communication via the non-terrestrial network. Alternatively, the electronic device 101 may perform a wireless communication via the non-terrestrial network regardless of a communication state with the terrestrial network.

According to one or more embodiments, the electronic device 101 may include a processor 120, a display module 160 (e.g., a display), a wireless communication module 192 (e.g., a communication circuit), and/or an antenna module 197. For example, the processor 120 may be operatively, functionally, and/or electrically connected to the display module 160, the wireless communication module 192, and/or the antenna module 197.

The processor 120 may execute, e.g., instructions (e.g., a program 140 in FIG. 1) at least temporarily stored in memory (e.g., memory 130 in FIG. 1) to control at least one other component (e.g., a hardware or software component) of the electronic device 101 connected to the processor 120, and may perform various data processing or computation. According to one or more embodiments, the processor 120 may control the overall operation related to a terrestrial network communication and/or non-terrestrial network communication. For example, the processor 120 may include a communication processor (e.g., an auxiliary processor 123 in FIG. 1) related to the terrestrial network communication and/or non-terrestrial network communication.

The display module 160 may visually provide information to the outside (e.g., a user) of the electronic device 101.

According to one or more embodiments, the display module 160 may display a user interface (UI) indicating information related to the terrestrial network and/or a non-terrestrial network. For example, the UI indicating the information related to the terrestrial network and/or the non-terrestrial network may include at least one of UIs indicating information related to a type of a network (e.g., cellular communication (3G, 4G, or 5G), short-range communication (e.g., BT, or WI-FI), or satellite communication), a type of network service provider (e.g., satellite communication service provider (Iridium), emergency service provider (ESP)), strength of a network signal (e.g., signal strength bars, RSSI, or RSRP), a direction of a communication device (satellite) included in a network (e.g., an orientation, an elevation angle, or an azimuth angle), presence information, and/or a network communication state (e.g., idle, transmit, or receive).

According to one or more embodiments, the display module 160 may display a UI indicating a service related to the terrestrial network and/or the non-terrestrial network.

According to one or more embodiments, the service related to the terrestrial network and/or the non-terrestrial network may include at least one of, e.g., an emergency message transmission service, a messaging service, a voice call, a video call, a data communication service, a location-related service, and/or a service related to an indicator.

According to one or more embodiments, the emergency message transmission service may include, but is not limited to, at least one of an SOS service state information providing service (e.g., display whether it is possible to provide an SOS service), a government office information providing service, an emergency contact information providing service, a text template providing service that minimizes text entry of the user, or a questionnaires service (e.g., a service for providing questionnaires, such as accident type, injured area, or medical information (e.g., age, gender, disease information, or medication information)) for quickly letting the emergency situation know.

According to one or more embodiments, the messaging service may include at least one of a short message service (SMS), a multimedia messaging service (MMS), or a rich communication suite (RCS) message, but is not limited thereto.

According to one or more embodiments, the data communication service may include a service via various applications (e.g., a web browser) that provide a data communication.

According to one or more embodiments, the location-related service may include, but is not limited to, at least one of longitude/latitude coordinates, location-related map information about the non-terrestrial wireless communication device 220, navigation, or a street view.

According to one or more embodiments, the UI example is not limited to the above-mentioned example, and may be provided via another output device (e.g., a sound output module 155 in FIG. 1).

According to one or more embodiments, the wireless communication module 192 may support various types of wireless communication bands supported by the electronic device 101. For example, a wireless communication band supported by the electronic device 101 may include a short-range wireless communication band (e.g., BT or Wi-Fi), a terrestrial network (e.g., cellular network) communication band, and/or a non-terrestrial network band, but is not limited thereto.

According to one or more embodiments, the electronic device 101 may support a frequency band (e.g., n255, or n256) related to a non-terrestrial network wireless communication. The electronic device 101 may perform the non-terrestrial network wireless communication using a frequency band related to non-terrestrial network wireless communication, but is not limited thereto. For example, the electronic device 101 may perform the non-terrestrial network wireless communication using at least a portion of the frequency band related to a terrestrial network wireless communication.

According to one or more embodiments, the antenna module 197 may transmit or receive a signal or power to or from the outside (e.g., an external electronic device).

According to one or more embodiments, the electronic device 101 may perform a wireless communication with the non-terrestrial network using at least one antenna among a plurality of antennas included in the antenna module 197. At least one antenna supporting the non-terrestrial wireless communication may include a dedicated antenna and/or a multi-use antenna. The dedicated antenna may include an antenna supporting the non-terrestrial network. The multi-use antenna may include an antenna that supports different types of networks and non-terrestrial networks together. For example, the electronic device 101 may communicate with at least one satellite (e.g., a GNSS satellite or a satellite for emergency message service) using at least one non-terrestrial network-dedicated antenna. For example, the multi-use antenna may include an antenna supporting a short-range communication network (e.g., a Bluetooth network or a Wi-Fi network) and/or a terrestrial network (e.g., a long term evolution (LTE) network). The electronic device 101 may support a non-terrestrial network using a plurality of antennas among antennas supporting the terrestrial network.

Hereinafter, in the disclosure, a satellite is mainly mentioned as the non-terrestrial wireless communication device 220, and even if it is mentioned that the satellite provides wireless communication using a specific radio access technology (RAT) (e.g., LTE) or a specific function (e.g., a base station), this is merely an example, and the type thereof is not limited.

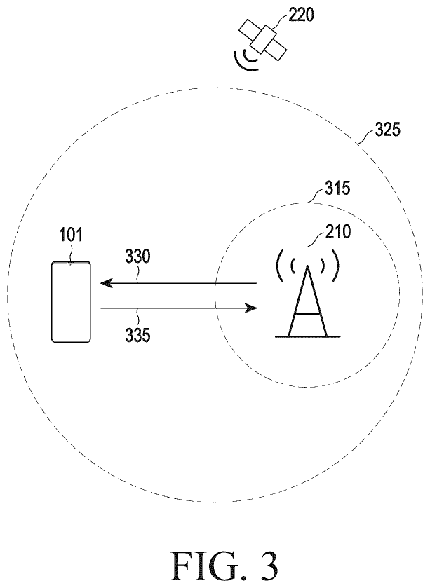

FIG. 3 is a diagram for describing an access of an electronic device according to one or more embodiments.

According to one or more embodiments, an electronic device 101 may be located within a coverage 315 (hereinafter, referred to as a terrestrial wireless communication coverage 315) of a terrestrial wireless communication device 210 and/or a coverage 325 (hereinafter, referred to as a non-terrestrial wireless communication coverage 325) of a non-terrestrial wireless communication device 220. The non-terrestrial wireless communication coverage 325 may be relatively larger (e.g., 50 times larger) than the terrestrial wireless communication coverage 315. For example, the non-terrestrial wireless communication coverage 325 may cover an area not covered by the coverage 315 of the terrestrial wireless communication device 210, and accordingly, the electronic device 101 may perform a communication even in an area where a terrestrial wireless communication is not supported.

According to one or more embodiments, the electronic device 101 may perform a cell scan within the terrestrial wireless communication coverage 315 and/or the non-terrestrial wireless communication coverage 325. As a result of performing the cell scan, the electronic device 101 may identify a cell provided by the terrestrial wireless communication device 210 and/or a cell provided by the non-terrestrial wireless communication device 220. If there is a cell that meets cell selection criteria, the electronic device 101 may perform at least some of operations for connecting to a network (e.g., a non-terrestrial network and/or a terrestrial network). Here, the connection to the network may include, e.g., at least some of a preceding operation (e.g., camping-on, or connection procedure (e.g., random access (RA) procedure)) for registration to the network and/or a registration operation (e.g., attach, or registration)) to the network, but is not limited thereto. If disconnection from the network is required (e.g., movement to another network), the electronic device 101 may perform at least some of disconnecting operations. The operations for disconnecting from the network may include at least some of a detach from the network, release of connection, and/or radio link failure (RLF) declaration, and is not limited to the listed operations.

According to one or more embodiments, the electronic device 101 may perform at least some of cell scan, disconnection from the network, and/or connection to the network according to movement 330 or 335.

According to one or more embodiments, if the electronic device 101 is located within the terrestrial communication coverage 315 included in the non-terrestrial wireless communication coverage 325 or is located at a boundary area of the terrestrial communication coverage 315, the electronic device 101 may connect to the terrestrial network and/or the non-terrestrial network based on a policy (e.g., a priority policy) of the electronic device 101.

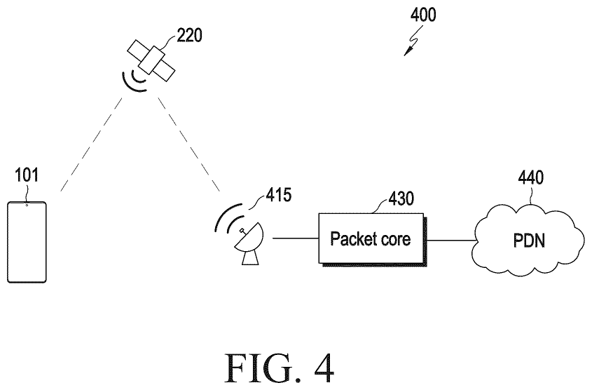

FIG. 4 is a diagram for describing a non-terrestrial network system 400 according to one or more embodiments.

Referring to FIG. 4, a non-terrestrial network system 400 may include a non-terrestrial wireless communication device 220, a radio unit 415, a packet core 430, and/or a PDN 440.

According to one or more embodiments, the non-terrestrial network system 400 may be implemented, e.g., in a regenerative scheme. When implemented in a regenerative scheme, the at least one non-terrestrial wireless communication device 220 may include a base station (e.g., eNode B). The non-terrestrial network system 400 may be implemented, e.g., in a bent-pipe scheme. The bent-pipe scheme may include a passive relay scheme that performs frequency conversion and power amplification on a received signal. If the non-terrestrial network system 400 is implemented in a bent-pipe scheme, the at least one non-terrestrial wireless communication device 220 may include a relay that converts (for example, amplifies) and transmits a signal. An implementation scheme of the non-terrestrial network system 400 and a role of the non-terrestrial wireless communication device 220 described in FIG. 4 are merely examples, and are not limited thereto.

According to one or more embodiments, the non-terrestrial wireless communication device 220 may include at least one satellite. The non-terrestrial wireless communication device 220 may communicate with, e.g., the electronic device 101 using a terrestrial network (e.g., a cellular network) band and/or a non-terrestrial network band. The terrestrial network band may be, e.g., an operating band supported by long term evolution (LTE) and/or new radio (NR), but is not limited thereto. The non-terrestrial network band may include a band (e.g., n255 and/or n256 bands) defined by 3GPP, but is not limited thereto.

According to one or more embodiments, the at least one radio unit 415 may receive a signal of the non-terrestrial wireless communication device 220 and transmit the signal to the packet core 430. The radio unit 415 and the non-terrestrial wireless communication device 220 may perform a communication using, e.g., the non-terrestrial network band. The non-terrestrial network band may be different from the terrestrial network band, but may be set to be the same in some cases.

According to one or more embodiments, the at least one packet core 430 may transmit and receive data associated with the electronic device 101 using the radio unit 415. Accordingly, the packet core 430 may process the data associated with the electronic device 101 and transmit the processed data to a packet data network (PDN) 440 (e.g., the Internet). The packet core 430 may include, e.g., at least some of an evolved packet core (EPC) and/or a 5G core (5GC), but is not limited thereto. The packet core 430 may include a packet core associated with an operator of the non-terrestrial wireless communication device 220 and/or a packet core associated with a mobile network operator (MNO). The packet core 430 may be additionally connected to a public switched telephone network (PSTN) to transmit and receive data associated with the electronic device 101.

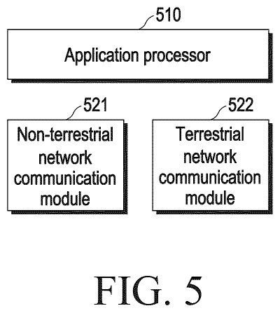

FIG. 5 is a drawing for describing an electronic device according to one or more embodiments.

According to one or more embodiments, an electronic device 101 may include an application processor 510, a non-terrestrial network communication module 521 (non-terrestrial network communication interface), and a terrestrial network communication module 522 (terrestrial network communication interface). Here, the application processor 510 may be, for example, at least a part of the processor 120 in FIG. 1, but is not limited thereto. The processor 120 may be operatively connected to, for example, the non-terrestrial network communication module 521 and the terrestrial network communication module 522, and may transmit/receive data for operations of the non-terrestrial network communication module 521 and the terrestrial network communication module 522, respectively, to/from the non-terrestrial network communication module 521 and the terrestrial network communication module 522. The non-terrestrial network communication module 521 and the terrestrial network communication module 522 may be implemented as independent modules (or circuits), as illustrated in FIG. 5, but is not limited thereto. For example, in another example, the non-terrestrial network communication module 521 and the terrestrial network communication module 522 may be implemented as one module (or circuit), and those skilled in the art will understand that a domain for a non-terrestrial network communication and a domain for a terrestrial network communication may be implemented independently within the one module (or circuit).

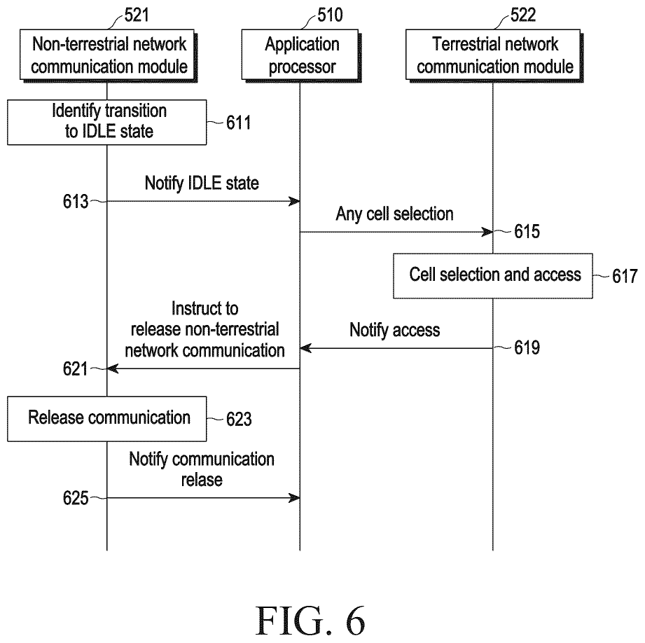

FIG. 6 is a drawing for describing an electronic device according to a comparative example for comparison with one or more embodiments.

Those skilled in the art will understand that at least some of operations according to a comparative example in FIG. 6 may be performed according to one or more embodiments.

A non-terrestrial network communication module 521 may, in operation 611, identify a transition to an IDLE state (e.g., radio resource control (RRC)_IDLE, but is not limited thereto) of a non-terrestrial network. For example, based on expiration of an RRC inactivity timer, an RRC may transit from an RRC connected state (RRC_CONNECTED state) to the RRC_IDLE state, but is not limited thereto.

The non-terrestrial network communication module 521 may, in operation 613, notify an application processor 510 of the IDLE state.

The application processor 510 may request any cell selection from a terrestrial network communication module 522 based on identifying the IDLE state of the non-terrestrial network in operation 615. For example, a cell which an electronic device 101 may select may include a suitable cell and an acceptable cell. The suitable cell may mean a cell which the electronic device 101 selects to receive a normal network service. The suitable cell may be a cell belonging to a public land mobile network (PLMN) in which the electronic device 101 may register. The acceptable cell is a cell for the electronic device 101 to receive a limited service which is not the normal network service. Unlike the suitable cell, the acceptable cell may be a cell of a PLMN in which the electronic device 101 may not register. The acceptable cell may be used for a purpose of providing an emergency service such as an emergency call. The any cell selection may mean that the electronic device 101 may select not only the suitable cell but also the acceptable cell. Accordingly, there is a possibility that the electronic device 101 will access the suitable cell, but there is also a possibility that the electronic device 101 will access the acceptable cell.

The terrestrial network communication module 522 may perform an operation for cell selection and access in operation 617. As described above, as the terrestrial network communication module 522 receives the request for the any cell selection, the terrestrial network communication module 522 may perform cell selection, and there is a possibility of selecting the suitable cell, but there is also a possibility of selecting the acceptable cell.

The terrestrial network communication module 522 may, in operation 619, notify the application processor 510 of the access.

The application processor 510 may, in operation 621, instruct to release a non-terrestrial network communication to the non-terrestrial network communication module 521 based on the identification of the access to the terrestrial network.

The non-terrestrial network communication module 521 may, in operation 623, perform at least one operation for releasing the non-terrestrial network communication in response to the instruction.

Based on the release of the non-terrestrial network communication, the non-terrestrial network communication module 521 may, in operation 625, notify the application processor 510 of the release of the communication.

As described above, according to the any cell selection, the electronic device 101 may access the terrestrial network based on the acceptable cell. In this case, even though message transmission and reception, a call service, and/or a data communication are possible via the non-terrestrial network, the electronic device 101 may access the terrestrial network based on the acceptable cell which supports only an emergency service. Accordingly, an access to the terrestrial network may need to be performed in consideration of a supported service, and this will be described with reference to embodiments.

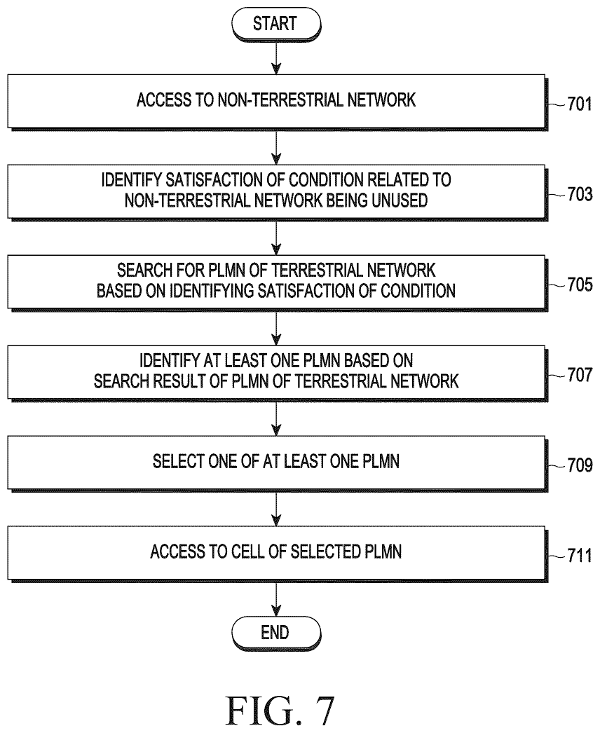

FIG. 7 is a drawing for describing an operating method of an electronic device according to one or more embodiments.

According to one or more embodiments, an electronic device 101 may, in operation 701, perform at least one operation for accessing a non-terrestrial network.

The electronic device 101 may, in operation 703, identify that a condition related to a non-terrestrial network being unused is satisfied. For example, the electronic device 101 may identify that a condition indicating that the non-terrestrial network is unused for a period equal to or longer than a specified period is satisfied. In an example, the electronic device 101 may identify that an RRC state for the non-terrestrial network transits into an RRC idle state as the satisfaction of the condition. For example, the RRC state may transit into the RRC idle state as an RRC inactivity timer expires because a non-terrestrial network communication is not performed. In an example, the electronic device 101 may identify that packets via the non-terrestrial network do not occur for the period equal to or longer than the specified period as the satisfaction of the condition. In an example, the electronic device 101 may identify that a preset timer expires after a request for PLMN search occurs as the satisfaction of the condition. There is no limitation on a type and/or number of conditions indicating that the non-terrestrial network is unused for the period equal to or longer than the specified period, and a detailed description of each example will be described below.

The electronic device 101 may search for a PLMN of a terrestrial network based on identifying the satisfaction of the condition in operation 705.

The electronic device 101 may, in operation 707, identify at least one PLMN based on a search result of the PLMN of the terrestrial network. For example, the at least one PLMN may be expressed as follows.
PLMN list [X, Y, Z, A, B, C, . . . ]

For example, the electronic device 101 may distinguish between a PLMN which supports a normal service and a PLMN which supports only a limited service, and there is no limitation on a distinguishing scheme. For example, the PLMN which supports the normal service may be a (equivalent) home public land mobile network ((E) HPLMN), a registered public land mobile network (RPLMN), an equivalent public land mobile network (EPLMN), or an operator public land mobile network (OPLMN), but there is no limitation therefor. The PLMN which supports the limited service may be a VPLMN, but there is no limitation therefor. In this case, information associated with a PLMN may be expressed as follows.
X: RPLMN->PLMN normal
Y: HPLMN->PLMN normal
Z: EPLMN->PLMN normal
A: other PLMN->PLMN limited
B: other PLMN->PLMN limited
C: other PLMN->PLMN limited

Alternatively, the PLMN which supports the normal service and the PLMN which supports only the limited service may be expressed as follows.
PLMN normal [X, Y, Z, . . . ]
PLMN limited [A, B, C, . . . ]

Alternatively, the electronic device 101 may manage whether there is the PLMN which provides the normal service and/or whether there is the PLMN which provides only the limited service, as follows.
NORMAL_SERVICE_AVAILABLE: 0 or 1
LIMITED_SERVICE_AVAILABLE: 0 or 1

In the above, 0 may represent, for example, absence of the PLMN which provides the normal service, and 1 may represent, for example, presence of the PLMN which provides the normal service, but there is no limitation therefor. In this case, if it is identified whether there is a PLMN, the electronic device 101 may perform a cell selection procedure thereafter, so those skilled in the art will understand that, as described above, only whether there is the PLMN which provides the normal service and/or whether there is the PLMN which provides only the limited service may be managed.

The electronic device 101 may, in operation 709, select one of the at least one PLMN. In one or more embodiments, the electronic device 101 may select one PLMN from the at least one PLMN supporting a normal service or a limited service as the first PLMN for accessing. For example, the electronic device 101 may identify user selection for the one of the at least one PLMN. The electronic device 101 may provide a user interface (UI) for selecting the one of the at least one PLMN (or some). The electronic device 101 may select the one PLMN based on the user selection via the UI. For example, the electronic device 101 may automatically select the one of the at least one PLMN without the user selection. For example, the electronic device 101 may identify a PLMN based on a priority of an identified PLMN, but there is no limitation therefor and various PLMN selection rules will be described later. The electronic device 101 may also select a PLMN based on a type of service supported by the non-terrestrial network, for example.

The electronic device 101 may, in operation 711, perform at least one operation for accessing a cell of the selected PLMN.

As described above, the electronic device 101 may first select the PLMN of the terrestrial network and then access the cell of the selected PLMN. Accordingly, even if, for example, the non-terrestrial network supports a text service and a call service, an access to an acceptable cell of the terrestrial network may be prevented.

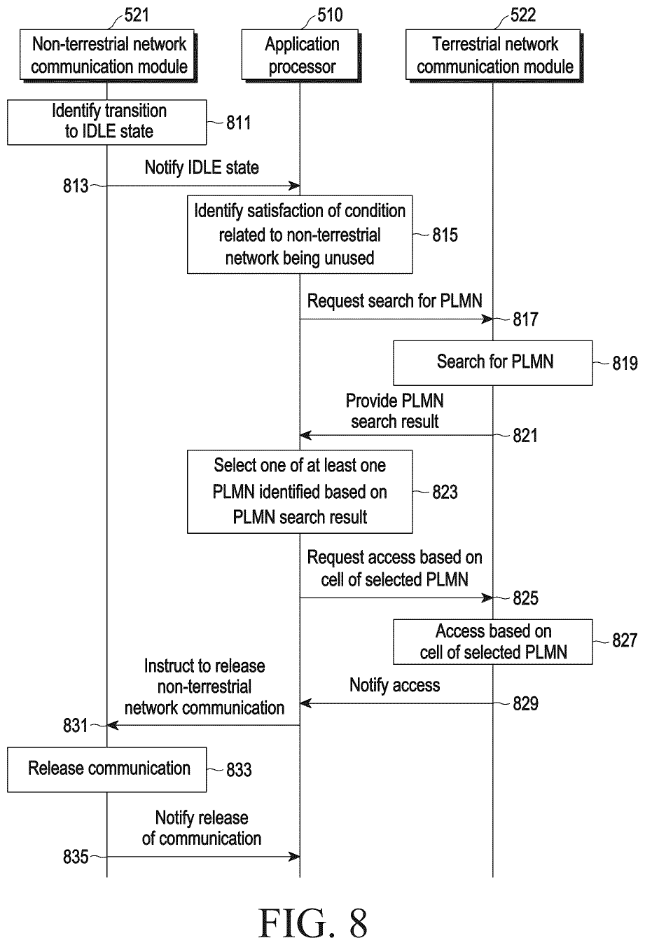

FIG. 8 is a drawing for describing an operating method of an electronic device according to one or more embodiments.

According to one or more embodiments, a non-terrestrial network communication module 521 may, in operation 811, identify a transition into an IDLE state. For example, the non-terrestrial network communication module 521 may transit an RRC state from an RRC_CONNECTED state to an RRC_IDLE state based on expiration of an RRC inactivity timer.

The non-terrestrial network communication module 521 may, in operation 813, notify an application processor 510 of the IDLE state.

The application processor 510 may, in operation 815, identify satisfaction of a condition related to a non-terrestrial network being unused. For example, the application processor 510 may identify that the RRC state corresponding to a non-terrestrial network is the RRC IDLE state as the satisfaction of the condition.

The application processor 510 may, in operation 817, request a search for a PLMN of a terrestrial network from a terrestrial network communication module 522 based on identifying the satisfaction of the condition.

The terrestrial network communication module 522 may perform a PLMN search in response to the request from the application processor 510 in operation 819.

The terrestrial network communication module 522 may, in operation 821, provide the application processor 510 with a PLMN search result. For example, the PLMN search result may include, but is not limited to, identification information of at least one identified PLMN and/or a type of service supported by the at least one PLMN.

The application processor 510 may select one of the at least one PLMN identified based on the PLMN search result in operation 823. For example, the application processor 510 may identify user selection for the one of the at least one PLMN. The application processor 510 may provide a UI for selecting the one of the at least one PLMN (or some). The application processor 510 may select the one of the PLMNs based on the user selection via the UI. For example, the application processor 510 may automatically select the one of the at least one PLMN without the user selection. For example, the application processor 510 may identify a PLMN based on a priority of an identified PLMN, but there is no limitation therefor, and various PLMN selection rules will be described later. The application processor 510 may select a PLMN according to a type of a service supported by the non-terrestrial network, for example.

The application processor 510 may, in operation 825, request an access based on a cell of the selected PLMN from the terrestrial network communication module 522. In other words, the application processor 510 may request an access using the cell of the selected PLMN.

The terrestrial network communication module 522 may, in operation 827, perform at least one operation for the access based on the cell of the selected PLMN in response to the request.

The terrestrial network communication module 522 may, based on a successful access, notify the application processor 510 of the access to the terrestrial network in operation 829.

The application processor 510 may, in operation 831, instruct to release a non-terrestrial network communication to the non-terrestrial network communication module 521 based on the identification of the access to the terrestrial network.

The non-terrestrial network communication module 521 may, in operation 833, perform at least one operation for releasing the non-terrestrial network communication in response to reception of the instruction.

The non-terrestrial network communication module 521 may, in operation 835, notify the application processor 510 of the release of the non-terrestrial network communication.

As described above, the electronic device 101 may first select the PLMN of the terrestrial network and then access the cell of the selected PLMN. Accordingly, even if, for example, the non-terrestrial network supports a text service and a call service, an access to an acceptable cell of the terrestrial network may be prevented.

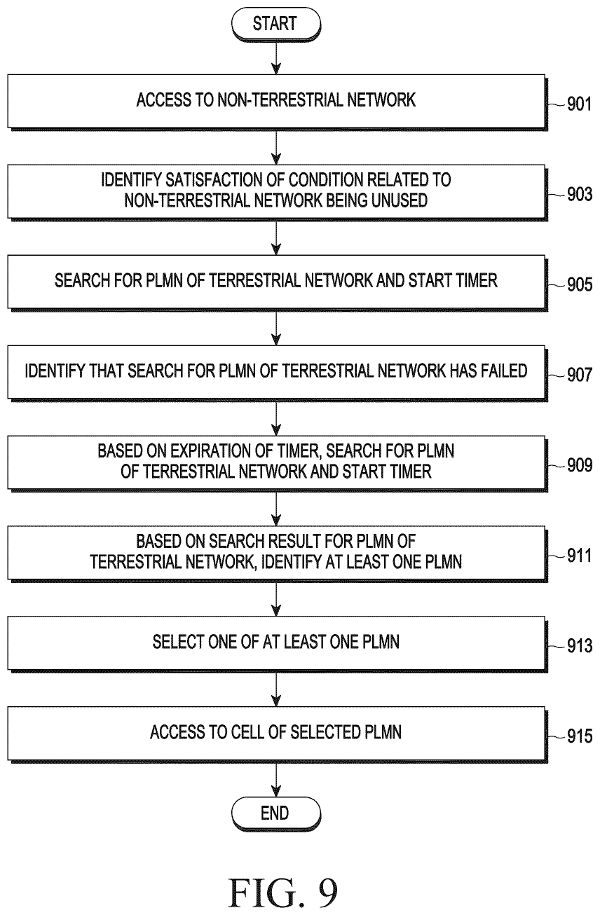

FIG. 9 is a drawing for describing an operating method of an electronic device according to one or more embodiments.

According to one or more embodiments, an electronic device 101 may, in operation 901, perform at least one operation for accessing a non-terrestrial network.

The electronic device 101 may, in operation 903, identify that a condition related to the non-terrestrial network being unused is satisfied. For example, the electronic device 101 may identify that a condition indicating that the non-terrestrial network is unused for a period equal to or longer than a specified period is satisfied.

The electronic device 101 may, in operation 905, search for a PLMN of a terrestrial network based on identifying the satisfaction of the condition, and may start a timer. A start event of the timer may be the satisfaction of the condition in operation 903, rather than the search for the PLMN of the terrestrial network.

The electronic device 101 may, in operation 907, identify that the search for the PLMN of the terrestrial network has failed. For example, the electronic device 101 may be located outside a coverage of the terrestrial network, and in this case, the search for the PLMN of the terrestrial network may fail, as in operation 907. For example, the timer started in operation 905 may be stopped (or reset) based on the search for the PLMN of the terrestrial network, and thus the timer may continue to run without being stopped and may eventually expire.

The electronic device 101 may search for a PLMN of the terrestrial network based on the expiration of the timer and restart the timer in operation 909. For example, the timer may be a timer for resuming the search for the PLMN of the terrestrial network. For example, the non-terrestrial network communication module 521 may provide the application processor 510 with information indicating an IDLE state as the timer expires while the IDLE state is maintained, and the application processor 510 may request the search for the PLMN of the terrestrial network from the terrestrial network communication module 522 based on this. In this case, the non-terrestrial network communication module 521 may reset and restart the timer after providing the application processor 510 with the information indicating the IDLE state, and when the timer expires, may provide the application processor 510 with information indicating the IDLE state again. Alternatively, the application processor 510 may request the search for the PLMN from the terrestrial network communication module 522 after receiving the information indicating the IDLE state from the non-terrestrial network communication module 521. After requesting the search for the PLMN, the application processor 510 may start the timer. If the timer expires while a PLMN list is not received, the application processor 510 may request a search for a PLMN from the terrestrial network communication module 522 again. As described above, there is no limitation on an entity managing the timer.

The electronic device 101 may, in operation 911, identify at least one PLMN based on the search result for the PLMN of the terrestrial network.

The electronic device 101 may, in operation 913, select one of the at least one PLMN. For example, the electronic device 101 may identify user selection for the one of the at least one PLMN. Alternatively, for example, the electronic device 101 may automatically select the one of the at least one PLMN without the user selection.

The electronic device 101 may perform at least one operation for accessing a cell of the selected PLMN in operation 915.

As described above, the electronic device 101 may first select the PLMN of the terrestrial network and then access the cell of the selected PLMN. Accordingly, even if, for example, the non-terrestrial network supports a text service and a call service, an access to an acceptable cell of the terrestrial network may be prevented.

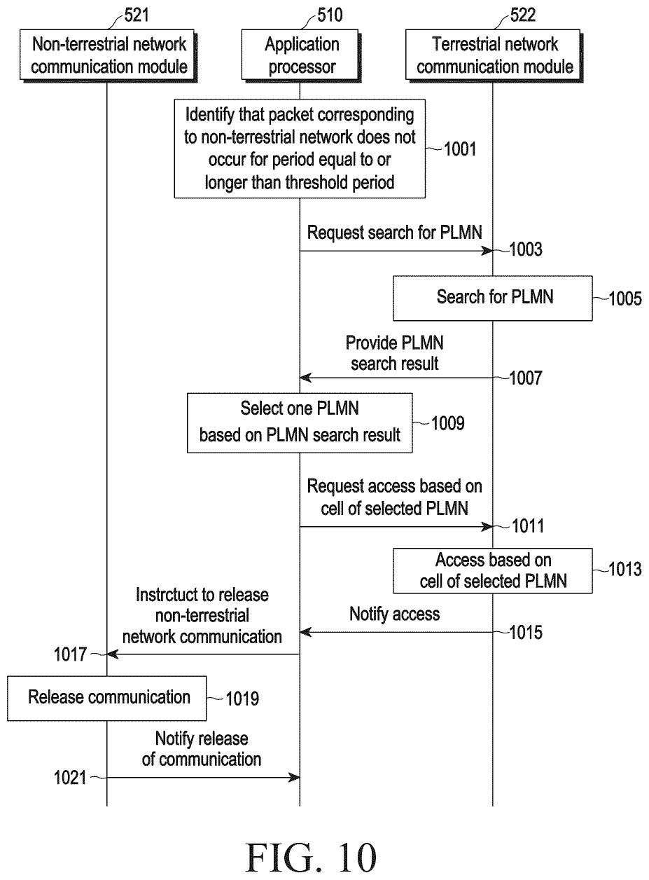

FIG. 10 is a drawing for describing an operating method of an electronic device according to one or more embodiments.

According to one or more embodiments, an application processor 510 may, in operation 1001, identify that a packet corresponding to a non-terrestrial network does not occur for a period equal to or longer than a threshold period as satisfaction of a condition related to a non-terrestrial network being unused. For example, the application processor 510 may monitor, while accessing the non-terrestrial network, whether an uplink packet from a running application and/or a downlink packet which needs to be provided to the running application occurs. Non-occurrence of the uplink packet and/or the downlink packet for the period equal to or longer than the threshold period may be identified as the satisfaction of the condition related to the non-terrestrial network being unused.

The application processor 510 may, in operation 1003, request a search for a PLMN of a terrestrial network from the terrestrial network communication module 522 based on identifying the satisfaction of the condition. The terrestrial network communication module 522 may, in operation 1005, perform a PLMN search in response to the request from the application processor 510.

The terrestrial network communication module 522 may, in operation 1007, provide the application processor 510 with a PLMN search result. For example, the PLMN search result may include, but is not limited to, identification information of at least one identified PLMN and/or a type of service supported by the at least one PLMN.

The application processor 510 may, in operation 1009, select one of the at least one PLMN identified based on the PLMN search result. For example, the application processor 510 may identify user selection for the one of the at least one PLMN. For example, the application processor 510 may automatically select the one of the at least one PLMN without the user selection.

The application processor 510 may, in operation 1011, request an access based on a cell of the selected PLMN to from terrestrial network communication module 522.

The terrestrial network communication module 522 may, in operation 1013, perform at least one operation for the access based on the cell of the selected PLMN in response to the request.

The terrestrial network communication module 522 may, based on a successful access, notify the application processor 510 of the access to the terrestrial network in operation 1015.

The application processor 510 may, in operation 1017, instruct release a non-terrestrial network communication to the non-terrestrial network communication module 521 based on the identification of the access to the terrestrial network.

The non-terrestrial network communication module 521 may, in operation 1019, perform at least one operation for releasing the non-terrestrial network communication in response to reception of the instruction.

The non-terrestrial network communication module 521 may, in operation 1021, notify the application processor 510 of the release of the non-terrestrial network communication.

As described above, the electronic device 101 may first select the PLMN of the terrestrial network and then access the cell of the selected PLMN. Accordingly, even if, for example, the non-terrestrial network supports a text service and a call service, an access to an acceptable cell of the terrestrial network may be prevented.

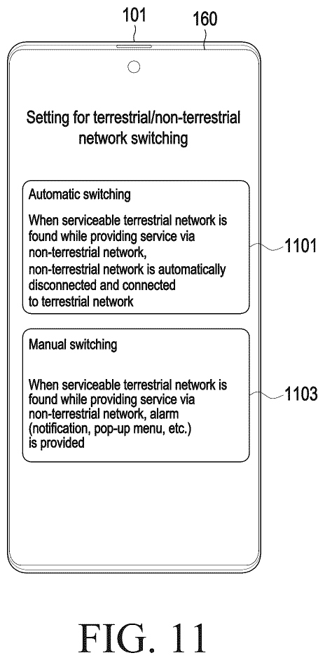

FIG. 11 is a drawing for describing a user interface provided by an electronic device according to one or more embodiments.

According to one or more embodiments, an electronic device 101 may provide a user interface including a visual element 1101 for selecting an automatic mode and a visual element 1103 for selecting a manual mode. The visual element 1101 for selecting the automatic mode may include text having a content indicating that a connection to a terrestrial network is automatically allowed without user selection while using a non-terrestrial network. The visual element 1103 for selecting the manual mode may include text having a content indicating that the connection to the terrestrial network is allowed according to the user selection while using the non-terrestrial network. For example, the electronic device 101 may determine a mode for switching to a terrestrial network based on selection of either of the visual elements 1101 and 1103.

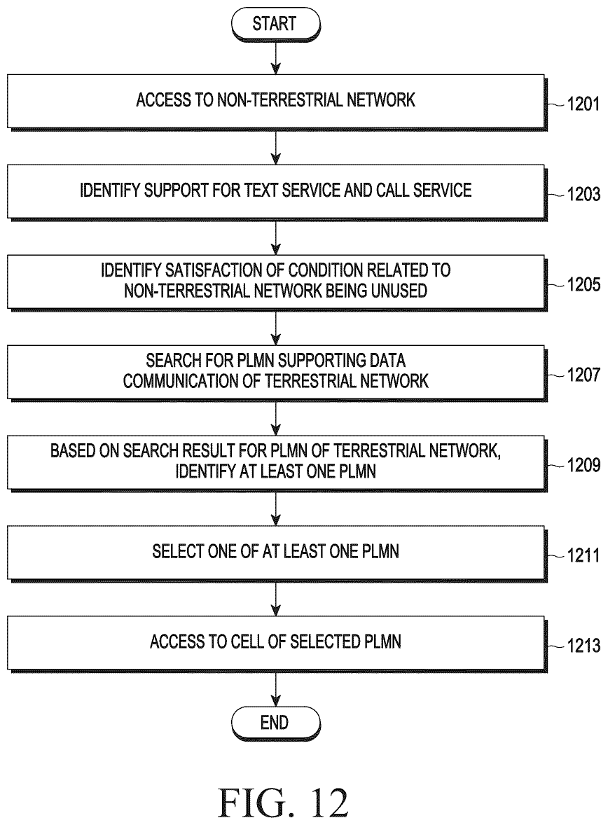

FIG. 12 is a drawing for describing an operating method of an electronic device according to one or more embodiments.

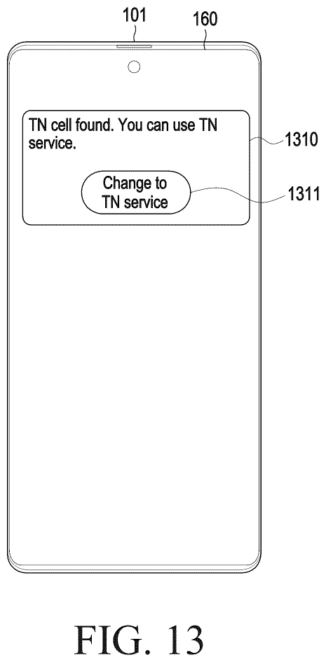

One or more embodiments in FIG. 12 will be described with reference to FIG. 13.

FIG. 13 is a drawing for describing a screen provided by an electronic device according to one or more embodiments.

According to one or more embodiments, an electronic device 101 may, in operation 1201, perform at least one operation for accessing a non-terrestrial network.

The electronic device 101 may, in operation 1203, identify that the non-terrestrial network supports a text service and a call service.

The electronic device 101 may, in operation 1205, identify that a condition related to the non-terrestrial network being unused is satisfied. For example, the electronic device 101 may identify that a condition indicating that the non-terrestrial network is unused for a period equal to or longer than a specified period is satisfied.

The electronic device 101 may search for a PLMN of a terrestrial network which supports a normal service in operation 1207. The normal service may include, for example, a text transmission/reception service, a call service, and a data transmission/reception service, but are not limited thereto. The PLMN which supports the normal service may be, for example, a PLMN in which the electronic device 101 may register based on a SIM connected to the electronic device 101 and/or a profile executed by the electronic device 101, but are not limited thereto. For example, the PLMN which supports the normal service may be, for example, an EHPLMN, an RPLMN, an EPLMN, and an OPLMN, but are not limited thereto. Since the non-terrestrial network supports the text service and the call service, the electronic device 101 may be configured to search for the PLMN which supports the normal service rather than all PLMNs. If the search for the PLMN which supports the normal service fails, the electronic device 101 may maintain the access to the non-terrestrial network and may perform a PLMN re-search based on timer expiration, for example, as described with reference to FIG. 9. Alternatively, if the search for the PLMN which supports the normal service fails and a PLMN which supports only a limited service is searched, the electronic device 101 may ask a user whether to switch to the PLMN which supports only the limited service. If a request to switch to the PLMN which supports only the limited service is received from the user, the electronic device 101 may be implemented to perform an access based on a cell of the PLMN which supports only the limited service.

The electronic device 101 may, in operation 1209, identify at least one PLMN based on a search result for the PLMN of the terrestrial network.

The electronic device 101 may, in operation 1211, select one of the at least one PLMN.

The electronic device 101 may perform at least one operation for accessing a cell of the selected PLMN in operation 1213.

For example, the electronic device 101 may be set to a manual mode. In this case, the electronic device 101 may express that a switchover access to the PLMN capable of providing the normal service of the terrestrial network is possible, as in FIG. 13. For example, the electronic device 101 may express a pop-up 1310 indicating that a terrestrial network cell has been searched and a terrestrial network service is available. The pop-up 1310 may include text indicating that the terrestrial network cell has been searched and the terrestrial network service is available. The pop-up 1301 may include a visual object 1311 causing the switchover access to the terrestrial network. Based on selection of the visual object 1311, the electronic device 101 may perform an access based on a cell of the PLMN which supports the normal service.

If PLMNs capable of supporting a plurality of normal services are identified, the electronic device 101 may provide a UI for selecting one of the PLMNs capable of supporting the plurality of normal services. If the one of the PLMNs capable of supporting the plurality of normal services is selected via the UI, the electronic device 101 may perform an access based on a cell of the selected PLMN.

For example, the electronic device 101 may be set to an automatic mode. In this case, the electronic device 101 may select one of the at least one PLMN which supports the normal service without the user selection. For example, the electronic device 101 may select the one of the at least one PLMN which supports the normal service based on a priority of the at least one PLMN which supports the normal service. Those skilled in the art will understand that the selection based on the priority of the PLMN may be performed, for example, by an application processor 510 and/or by a terrestrial network communication module 522.

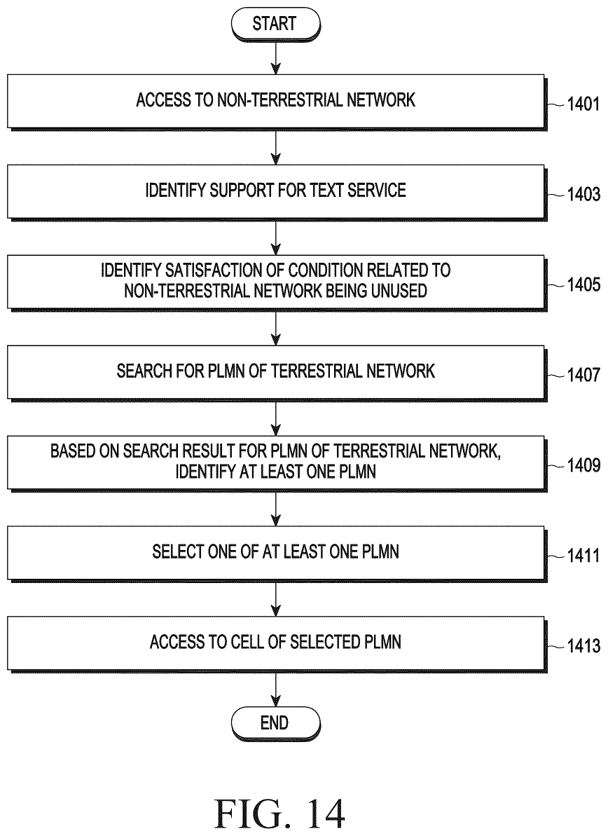

FIG. 14 is a drawing for describing an operating method of an electronic device according to one or more embodiments.

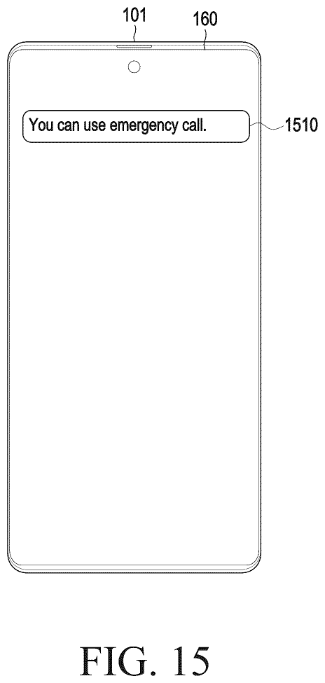

One or more embodiments in FIG. 14 will be described with reference to FIG. 15.

FIG. 15 is a drawing for describing a screen provided by an electronic device according to one or more embodiments.

According to one or more embodiments, an electronic device 101 may, in operation 1401, perform at least one operation for accessing a non-terrestrial network.

The electronic device 101 may, in operation 1403, identify that the non-terrestrial network supports a text service and does not support a call service.

The electronic device 101 may, in operation 1405, identify that a condition related to the non-terrestrial network being unused is satisfied. For example, the electronic device 101 may identify that a condition indicating that the non-terrestrial network is unused for a period equal to or longer than a specified period is satisfied.

The electronic device 101 may search for a PLMN of a terrestrial network in operation 1407. The electronic device 101 may search for a PLMN which supports only a limited service as well as a PLMN which supports a normal service. Since an emergency call service may be supported via the limited service, if the non-terrestrial network only supports the text service, an access to a limited PLMN may be advantageous.

As described above, for example, a PLMN which supports the normal service and a PLMN which supports only the limited service may be distinguished and managed as follows.
PLMN normal [X, Y, Z, . . . ]
PLMN limited [A, B, C, . . . ]

Alternatively, the electronic device 101 may exclude a PLMN which supports only the limited service from a selection list if a PLMN which supports the normal service is identified. In this case, if the PLMN which supports the normal service is not identified, the electronic device 101 may include the PLMN which supports only the limited service in the selection list, and an example of this is as follows.
PLMN normal [X, Y, Z, . . . n]

Alternatively, if the PLMN which supports the normal service is not identified, the electronic device 101 may express only whether the PLMN which supports only the limited service has been found, as follows.
LIMITED_SERVICE_AVAILABLE: 0 or 1

Alternatively, the electronic device 101 may express only whether a PLMN has been found, as follows:
PLMN_FOUND: 0 or 1

The electronic device 101 may, in operation 1409, identify at least one PLMN based on a search result for the PLMN of the terrestrial network.

The electronic device 101 may, in operation 1411, select one of the at least one PLMN.

The electronic device 101 may perform at least one operation for accessing a cell of the selected PLMN in operation 1413.

For example, the electronic device 101 may be set to a manual mode. In this case, the electronic device 101 may express that a switchover access to the PLMN capable of providing the limited service of the terrestrial network is possible, as in FIG. 15. As described above, for example, if the electronic device 101 fails to search for the PLMN which supports the normal service and succeeds in searching for the PLMN which supports the limited service, the electronic device 101 may express a pop-up 1510 indicating that a terrestrial network cell has been searched and that the limited service is available. If the pop-up 1510 is selected, the electronic device 101 may perform an access based on a cell of the PLMN which supports the limited service. If no other user manipulation is identified, the electronic device 101 may maintain the access to the non-terrestrial network. Thereafter, if a user intends to make an emergency call, the access to the PLMN which supports the limited service may be performed based on user manipulation for the electronic device 101.

If PLMNs capable of supporting a plurality of limited services are identified, the electronic device 101 may provide a UI for selecting one of the PLMNs capable of supporting the plurality of limited services. If the one of the PLMNs capable of supporting the plurality of limited services is selected via the UI, the electronic device 101 may perform an access based on a cell of the selected PLMN. Alternatively, those skilled in the art will understand that the electronic device 101 may express a PLMN capable of supporting a limited service and a PLMN capable of supporting a normal service as a list.

For example, the electronic device 101 may be set to an automatic mode. In this case, the electronic device 101 may be implemented to select one of the at least one PLMN which supports the limited service without user selection. If the electronic device 101 is set to the automatic mode and only PLMN which supports the limited service is searched, the electronic device 101 may be implemented to maintain the access to the non-terrestrial network.

A PLMN which supports the normal service may be searched. If the electronic device 101 is set to the manual mode, the electronic device 101 may provide a UI as described with reference to FIG. 13, for example, and perform an access based on a cell of a PLMN which supports the normal service based on a user command via the UI. Alternatively, if the electronic device 101 is set to the automatic mode, the electronic device 101 may select one of the PLMNs which support the normal service.

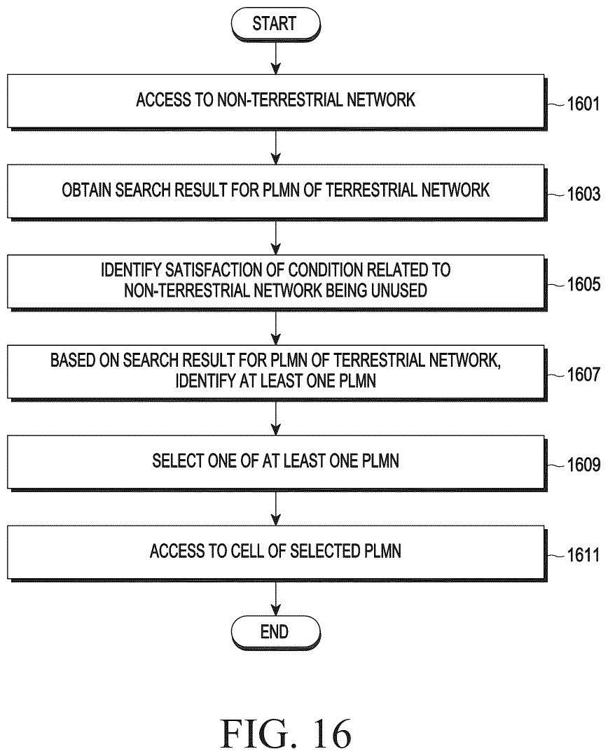

FIG. 16 is a drawing for describing an operating method of an electronic device according to one or more embodiments.

According to one or more embodiments, an electronic device 101 may, in operation 1601, perform at least one operation for accessing a non-terrestrial network.

The electronic device 101 may obtain a search result for a PLMN of a terrestrial network in operation 1603. For example, the electronic device 101 may perform a search corresponding to a frequency (or an RF path) of the terrestrial network which is different from a frequency (or an RF path) used for the non-terrestrial network. For example, the electronic device 101 may perform a search corresponding to the terrestrial network using a resource block (RB) which is not allocated for use in the non-terrestrial network.

The electronic device 101 may, in operation 1605, identify that a condition related to the non-terrestrial network being unused is satisfied. For example, the electronic device 101 may identify that a condition indicating that the non-terrestrial network is not used for a period equal to or longer than a specified period is satisfied.

The electronic device 101 may, in operation 1607, identify at least one PLMN based on a search result for a PLMN of the terrestrial network, based on identifying the satisfaction of the condition related to the non-terrestrial network being unused.

The electronic device 101 may, in operation 1609, select one of the at least one PLMN. For example, the electronic device 101 may identify user selection for the one of the at least one PLMN. Alternatively, for example, the electronic device 101 may automatically select the one of the at least one PLMN without the user selection.

The electronic device 101 may perform at least one operation for accessing a cell of the selected PLMN in operation 1611.

As described above, the electronic device 101 may first select the PLMN of the terrestrial network and then access the cell of the selected PLMN. Accordingly, even if, for example, the non-terrestrial network supports a text service and a call service, an access to an acceptable cell of the terrestrial network may be prevented.

According to one or more embodiments of the disclosure, an electronic device (101) may include at least one application processor (120; 510) comprising processing circuitry, at least one communication module (521,522) comprising communication circuitry, and memory (130) storing instructions.

According to one or more embodiments of the disclosure, the instructions, when executed by the at least one application processor (120; 510) individually or collectively, may cause the electronic device (101) to identify, by the at least one application processor (120; 510), satisfaction of a condition indicating that a non-terrestrial network is not used for a period equal to or longer than a specified period, after the electronic device (101) accesses a non-terrestrial network based on the at least one communication module (521,522).

According to one or more embodiments of the disclosure, the instructions, when executed by the at least one application processor (120; 510) individually or collectively, may cause the electronic device (101) to, based on the satisfaction of the condition, obtain, by the at least one application processor (120; 510), a search result for a public land mobile network (PLMN) of a terrestrial network by requesting a search for the PLMN of the terrestrial network from the at least one communication module (521,522), and the at least one communication module (521,522) may provide the at least one application processor (120; 510) with the search result for the PLMN of the terrestrial network in response to the request.

According to one or more embodiments of the disclosure, the instructions, when executed by the at least one application processor (120; 510) individually or collectively, may cause the electronic device (101) to select, by the at least one application processor (120; 510), a first PLMN from at least one PLMN of the terrestrial network which is identified based on the search result for the PLMN of the terrestrial network.

According to one or more embodiments of the disclosure, the instructions, when executed by the at least one application processor (120; 510) individually or collectively, may cause the electronic device (101) to request, by the at least one application processor (120; 510), an access to the first PLMN from the at least one communication module (521,522).

According to one or more embodiments of the disclosure, the instructions, when executed by the at least one application processor (120; 510) individually or collectively, may cause the electronic device (101) to, in response to the request for the access to the first PLMN, perform, by the at least one communication module (521,522), at least one operation for an access which is based on a cell of the first PLMN.

According to one or more embodiments of the disclosure, the instructions, when executed by the at least one application processor (120; 510) individually or collectively, may cause the electronic device (101) to, as at least part of selecting the first PLMN from the at least one PLMN of the terrestrial network, select the first PLMN from the at least one PLMN of the terrestrial network based on a service supported by the non-terrestrial network.

According to one or more embodiments of the disclosure, the instructions, when executed by the at least one application processor (120; 510) individually or collectively, may cause the electronic device (101) to, as at least part of selecting the first PLMN from the at least one PLMN of the terrestrial network based on the service supported by the non-terrestrial network, based on the non-terrestrial network supporting a text message service and a call service, select one PLMN from at least one PLMN supporting a normal service as the first PLMN.

According to one or more embodiments of the disclosure, the at least one PLMN supporting the normal service may comprise at least one of a home public land mobile network (HPLMN), an equivalent home public land mobile network (EHPLMN), a registered public land mobile network (RPLMN), an equivalent public land mobile network (EPLMN), or an operator public land mobile network (OPLMN).

According to one or more embodiments of the disclosure, the instructions, when executed by the at least one application processor (120; 510) individually or collectively, may cause the electronic device (101) to, as at least part of selecting the PLMN from the at least one PLMN supporting the normal service as the first PLMN, identify a user command for causing selection of the one PLMN from the at least one PLMN supporting the normal service as the first PLMN.

According to one or more embodiments of the disclosure, the instructions, when executed by the at least one application processor (120; 510) individually or collectively, may cause the electronic device (101) to, as at least part of selecting the PLMN from the at least one PLMN supporting the normal service as the first PLMN, based on the user command, select the one PLMN from the at least one PLMN supporting the normal service as the first PLMN.

According to one or more embodiments of the disclosure, the instructions, when executed by the at least one application processor (120; 510) individually or collectively, may cause the electronic device (101) to, as at least part of selecting the one PLMN from the at least one PLMN supporting the normal service as the first PLMN, based on a priority of the at least one PLMN supporting the normal service, select the one PLMN from the at least one PLMN supporting the normal service as the first PLMN.

According to one or more embodiments of the disclosure, the instructions, when executed by the at least one application processor (120; 510) individually or collectively, may cause the electronic device (101) to, as at least part of selecting the first PLMN from the at least one PLMN of the terrestrial network based on the service supported by the non-terrestrial network, based on the non-terrestrial network supporting a text message service and not supporting a call service, select one PLMN from at least one PLMN supporting a normal service and/or at least one PLMN supporting a limited service as the first PLMN.

According to one or more embodiments of the disclosure, the at least one PLMN supporting the normal service may comprise at least one of a home public land mobile network (HPLMN), an equivalent home public land mobile network (EHPLMN), a registered public land mobile network (RPLMN), an equivalent public land mobile network (EPLMN), or an operator public land mobile network (OPLMN).

According to one or more embodiments of the disclosure, the at least one PLMN supporting the limited service may comprise a visited home public land mobile network (VPLMN).

According to one or more embodiments of the disclosure, the instructions, when executed by the at least one application processor (120; 510) individually or collectively, may cause the electronic device (101) to, as at least part of selecting the one PLMN from the at least one PLMN supporting the normal service and/or the at least one PLMN supporting the limited service as the first PLMN, based on identifying the at least one PLMN supporting the normal service and the at least one PLMN supporting the limited service, select the one PLMN from the at least one PLMN supporting the normal service as the first PLMN.

According to one or more embodiments of the disclosure, the instructions, when executed by the at least one application processor (120; 510) individually or collectively, may cause the electronic device (101) to, as at least part of selecting the one PLMN from the at least one PLMN supporting the normal service as the first PLMN based on identifying the at least one PLMN supporting the normal service and the at least one PLMN supporting the limited service, identify a user command for causing selection of the one PLMN from the at least one PLMN supporting the normal service as the first PLMN.

According to one or more embodiments of the disclosure, the instructions, when executed by the at least one application processor (120; 510) individually or collectively, may cause the electronic device (101) to, as at least part of selecting the one PLMN from the at least one PLMN supporting the normal service as the first PLMN based on identifying the at least one PLMN supporting the normal service and the at least one PLMN supporting the limited service, based on the user command, select the one PLMN from the at least one PLMN supporting the normal service as the first PLMN.

According to one or more embodiments of the disclosure, the instructions, when executed by the at least one application processor (120; 510) individually or collectively, may cause the electronic device (101) to, as at least part of selecting the one PLMN from the at least one PLMN supporting the normal service as the first PLMN based on identifying the at least one PLMN supporting the normal service and the at least one PLMN supporting the limited service, based on a priority of the at least one PLMN supporting the normal service, select the one PLMN from the at least one PLMN supporting the normal service as the first PLMN.

According to one or more embodiments of the disclosure, the instructions, when executed by the at least one application processor (120; 510) individually or collectively, may cause the electronic device (101) to, as at least part of selecting the one PLMN from the at least one PLMN supporting the normal service and/or the at least one PLMN supporting the limited service as the first PLMN based on the non-terrestrial network supporting the text message service and not supporting the call service, based on identification of the at least one PLMN supporting the limited service and failure of identifying the at least one PLMN supporting the normal service, select the one PLMN from the at least one PLMN supporting the limited service as the first PLMN based on identifying a user command for causing an access to the one PLMN of the the at least one PLMN supporting the limited service.

According to one or more embodiments of the disclosure, the instructions, when executed by the at least one application processor (120; 510) individually or collectively, may cause the electronic device (101) to, as at least part of identifying the satisfaction of the condition indicating that the non-terrestrial network is not used for the period equal to or longer than the specified period, identify a radio resource control (RRC) state of the non-terrestrial network being RRC idle state, as the satisfaction of the condition.

According to one or more embodiments of the disclosure, the instructions, when executed by the at least one application processor (120; 510) individually or collectively, cause the electronic device (101) to, as at least part of identifying the satisfaction of the condition indicating that the non-terrestrial network is not used for the period equal to or longer than the specified period, identify non-occurrence of a packet associated with the non-terrestrial network during the period equal to or longer than the specified period, as the satisfaction of the condition.

According to one or more embodiments of the disclosure, the instructions, when executed by the at least one application processor (120; 510) individually or collectively, may cause the electronic device (101) to, based on failure of identifying a PLMN of the terrestrial network based on the search result for the PLMN of the terrestrial network, repeatedly perform the search for the PLMN of the terrestrial network periodically.

According to one or more embodiments of the disclosure, an operating method of an electronic device (101) including at least one application processor (120; 510) including processing circuitry and at least one communication module (521, 522) including communication circuitry may be provided.

According to one or more embodiments of the disclosure, the operating method of the electronic device (101) may include identifying, by the at least one application processor (120; 510), satisfaction of a condition indicating that a non-terrestrial network is not used for a period equal to or longer than a specified period, after the electronic device (101) accesses the non-terrestrial network based on the at least one communication module (521,522).

According to one or more embodiments of the disclosure, the operating method of the electronic device (101) may include obtaining, by the at least one application processor (120; 510), a search result for a public land mobile network (PLMN) of a terrestrial network by requesting a search for the PLMN of the terrestrial network from the at least one communication module (521,522), based on the satisfaction of the condition and providing, by the at least one communication module (521,522), the at least one application processor (120; 510) with the search result for the PLMN of the terrestrial network in response to the request.

According to one or more embodiments of the disclosure, the operating method of the electronic device (101) may include selecting, by the at least one application processor (120; 510), a first PLMN from at least one PLMN of the terrestrial network which is identified based on the search result for the PLMN of the terrestrial network;

According to one or more embodiments of the disclosure, the operating method of the electronic device (101) may include requesting, by the at least one application processor (120; 510), an access to the first PLMN from the at least one communication module (521,522).

According to one or more embodiments of the disclosure, the operating method of the electronic device (101) may include performing, by the at least one communication module (521,522), at least one operation for an access which is based on a cell of the first PLMN, in response to the request for the access to the first PLMN.

According to one or more embodiments of the disclosure, the selecting the first PLMN from the at least one PLMN of the terrestrial network may include selecting the first PLMN from the at least one PLMN of the terrestrial network based on a type of a service supported by the non-terrestrial network.

According to one or more embodiments of the disclosure, the selecting the first PLMN from the at least one PLMN of the terrestrial network based on the service supported by the non-terrestrial network may include, based on the non-terrestrial network supporting a text message service and a call service, selecting one PLMN from at least one PLMN supporting a normal service as the first PLMN.

According to one or more embodiments of the disclosure, the at least one PLMN supporting the normal service may include at least one of a home public land mobile network (HPLMN), an equivalent home public land mobile network (EHPLMN), a registered or an operator public land mobile network (OPLMN).

According to one or more embodiments of the disclosure, the selecting the PLMN from the at least one PLMN supporting the normal service as the first PLMN may include identifying a user command for causing selection of the one PLMN from the at least one PLMN supporting the normal service as the first PLMN.

According to one or more embodiments of the disclosure, the selecting the PLMN from the at least one PLMN supporting the normal service as the first PLMN may include, based on the user command, selecting the one PLMN from the at least one PLMN supporting the normal service as the first PLMN.

According to one or more embodiments of the disclosure, the selecting the one PLMN from the at least one PLMN supporting the normal service as the first PLMN may include, based on a priority of the at least one PLMN supporting the normal service, selecting the one PLMN from the at least one PLMN supporting the normal service as the first PLMN.

According to one or more embodiments of the disclosure, selecting the first PLMN from the at least one PLMN of the terrestrial network based on the service supported by the non-terrestrial network may include, based on the non-terrestrial network supporting a text message service and not supporting a call service, selecting one PLMN from at least one PLMN supporting a normal service and/or at least one PLMN supporting a limited service as the first PLMN.

According to one or more embodiments of the disclosure, the at least one PLMN supporting the normal service may include at least one of a home public land mobile network (HPLMN), an equivalent home public land mobile network (EHPLMN), a registered or an operator public land mobile network (OPLMN),

According to one or more embodiments of the disclosure, the at least one PLMN supporting the limited service may include a visited home public land mobile network (VPLMN).

According to one or more embodiments of the disclosure, a storage medium storing computer-readable instructions may be provided.

According to one or more embodiments of the disclosure, the instructions, when executed by at least one processor (120; 510) including processing circuitry of an electronic device (101) individually or collectively, may cause the electronic device (101) to identify satisfaction of a condition indicating that a non-terrestrial network is not used for a period equal to or longer than a specified period, after the electronic device (101) accesses the non-terrestrial network based on at least one communication module (521,522) including communication circuitry.

According to one or more embodiments of the disclosure, the instructions, when executed by at least one processor (120; 510) including processing circuitry of an electronic device (101) individually or collectively, may cause the electronic device (101) to, based on the satisfaction of the condition, obtain a search result for a public land mobile network (PLMN) of a terrestrial network.

According to one or more embodiments of the disclosure, the instructions, when executed by at least one processor (120; 510) including processing circuitry of an electronic device (101) individually or collectively, may cause the electronic device (101) to select a first PLMN from at least one PLMN of the terrestrial network which is identified based on the search result for the PLMN of the terrestrial network.

According to one or more embodiments of the disclosure, the instructions, when executed by at least one processor (120; 510) including processing circuitry of an electronic device (101) individually or collectively, may cause the electronic device (101) to perform at least one operation for an access which is based on a cell of the first PLMN. In other words, the electronic device may control the at least one communication interface to perform at least one operation for the access using the cell of the first PLMN.

According to one or more embodiments of the disclosure, an electronic device (101) may comprise at least one application processor (120; 510) comprising processing circuitry, at least one communication module (521,522) comprising communication circuitry, and memory (130) storing instructions.

According to one or more embodiments of the disclosure, the instructions, when executed by the at least one application processor (120; 510) individually or collectively, may cause the electronic device (101) to obtain, by the at least one application processor (120; 510), a search result for a public land mobile network (PLMN) of a terrestrial network by requesting a search for the PLMN of the terrestrial network from the at least one communication module (521,522), and the at least one communication module (521,522) may provide the at least one application processor with the search result for the PLMN of the terrestrial network in response to the request.

According to one or more embodiments of the disclosure, the instructions, when executed by the at least one application processor (120; 510) individually or collectively, may cause the electronic device (101) to identify, by the at least one application processor (120; 510), satisfaction of a condition indicating that a non-terrestrial network is not used for a period equal to or longer than a specified period, after the electronic device (101) accesses the non-terrestrial network based on the at least one communication module (521,522).

According to one or more embodiments of the disclosure, the instructions, when executed by the at least one application processor (120; 510) individually or collectively, may cause the electronic device (101) to, based on the satisfaction of the condition, select, by the at least one application processor (120; 510), a first PLMN from at least one PLMN of the terrestrial network which is identified based on the search result for the PLMN of the terrestrial network.

According to one or more embodiments of the disclosure, the instructions, when executed by the at least one application processor (120; 510) individually or collectively, may cause the electronic device (101) to request, by the at least one application processor (120; 510), an access to the first PLMN from the at least one communication module (521,522).

According to one or more embodiments of the disclosure, the instructions, when executed by the at least one application processor (120; 510) individually or collectively, may cause the electronic device (101) to, in response to the request for the access to the first PLMN, perform, by the at least one communication module (521,522), at least one operation for an access which is based on a cell of the first PLMN.

According to one or more embodiments of the disclosure, an operating method of an electronic device (101) including at least one application processor (120; 510) including processing circuitry and at least one communication module (521,522) including communication circuitry may be provided.

According to one or more embodiments of the disclosure, the operating method of the electronic device (101) may include obtaining, by the at least one application processor (120; 510), a search result for a public land mobile network (PLMN) of a terrestrial network by requesting a search for the PLMN of the terrestrial network from the at least one communication module (521,522).

According to one or more embodiments of the disclosure, the at least one communication module (521,522) may provide the at least one application processor (120; 510) with the search result for the PLMN of the terrestrial network in response to the request.

According to one or more embodiments of the disclosure, the operating method of the electronic device (101) may include identifying, by the at least one application processor (120; 510), satisfaction of a condition indicating that a non-terrestrial network is not used for a period equal to or longer than a specified period, after the electronic device (101) accesses the non-terrestrial network based on the at least one communication module (521,522).

According to one or more embodiments of the disclosure, the operating method of the electronic device (101) may include, based on the satisfaction of the condition, selecting, by the at least one application processor (120; 510), a first PLMN from at least one PLMN of the terrestrial network which is identified based on the search result for the PLMN of the terrestrial network.

According to one or more embodiments of the disclosure, the operating method of the electronic device (101) may include requesting, by the at least one application processor (120; 510), an access to the first PLMN from the at least one communication module (521,522).

According to one or more embodiments of the disclosure, the operating method of the electronic device (101) may include performing, by the at least one communication module (521,522), at least one operation for an access which is based on a cell of the first PLMN, in response to the request for the access to the first PLMN.

According to one or more embodiments of the disclosure, a storage medium storing computer-readable instructions may be provided.

According to one or more embodiments of the disclosure, the instructions, when executed by at least one processor (120; 510) of an electronic device (101) individually or collectively, may cause the electronic device (101) to obtain a search result for a public land mobile network (PLMN) of a terrestrial network.

According to one or more embodiments of the disclosure, the instructions, when executed by the at least one processor (120; 510) individually or collectively, may cause the electronic device (101) to identify satisfaction of a condition indicating that a non-terrestrial network is not used for a period equal to or longer than a specified period, after the electronic device (101) accesses the non-terrestrial network based on the at least one communication module (521,522).

According to one or more embodiments of the disclosure, the instructions, when executed by the at least one processor (120; 510) individually or collectively, may cause the electronic device (101) to, based on the satisfaction of the condition, select a first PLMN from at least one PLMN of the terrestrial network which is identified based on the search result for the PLMN of the terrestrial network.

According to one or more embodiments of the disclosure, the instructions, when executed by the at least one processor (120; 510) individually or collectively, may cause the electronic device (101) to perform at least one operation for an access which is based on a cell of the first PLMN.

The electronic device according to an embodiment may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that an embodiment of the disclosure and the terms used therein are not intended to limit the technological features set forth herein to a particular embodiment and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with an embodiment of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or two or more functions. For example, according to an embodiment, the module may be implemented in a form of an application-specific integrated circuit (ASIC).

An embodiment as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to an embodiment of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to an embodiment, each component (e.g., a module or a program) of the above-described components may include a single entity or multiple entities, and some of the multiple entities may be separately disposed in different components. According to an embodiment, one or more of the above-described components or operations may be omitted, or one or more other components or operations may be added. Alternatively or additionally, a plurality of components (e.g., modules or programs) may be integrated into a single component. In such a case, the integrated component may still perform one or more functions of each of the plurality of components in the same or similar manner as they are performed by a corresponding one of the plurality of components before the integration. According to an embodiment, operations performed by the module, the program, or another component may be carried out sequentially, in parallel, repeatedly, or heuristically, or one or more of the operations may be executed in a different order or omitted, or one or more other operations may be added.

What is claimed is:

1. An electronic device comprising:
at least one processor comprising processing circuitry;
at least one communication module comprising communication circuitry; and
memory storing instructions, wherein the instructions, when executed by the at least one processor individually or collectively, cause the electronic device to:
after the electronic device accesses a non-terrestrial network using the at least one communication module, identify satisfaction of a condition indicating that the non-terrestrial network is not used for at least a specified period of time,
based on the satisfaction of the condition, obtain a search result for at least one public land mobile network (PLMN) of a terrestrial network by requesting a search for the at least one PLMN of the terrestrial network from the at least one communication module, wherein the at least one communication module is configured to provide the at least one processor with the search result for the at least one PLMN of the terrestrial network based on the requesting the search,
select a first PLMN from the at least one PLMN of the terrestrial network identified based on the search result;
request an access to the first PLMN from the at least one communication module, and
control the at least one communication module to, based on the request for the access to the first PLMN, perform at least one operation for the access using a cell of the first PLMN.

2. The electronic device of claim 1, wherein the instructions, when executed by the at least one processor individually or collectively, further cause the electronic device to, as at least part of selecting the first PLMN from the at least one PLMN of the terrestrial network:
select the first PLMN from the at least one PLMN of the terrestrial network based on a service supported by the non-terrestrial network.

3. The electronic device of claim 2, wherein the instructions, when executed by the at least one processor individually or collectively, cause the electronic device to, as at least part of selecting the first PLMN from the at least one PLMN of the terrestrial network based on the service supported by the non-terrestrial network:
based on the non-terrestrial network supporting a text message service and a call service, select, one PLMN from at least one PLMN supporting a normal service as the first PLMN, and
wherein the at least one PLMN supporting the normal service comprises at least one of a home public land mobile network (HPLMN), an equivalent home public land mobile network (EHPLMN), a registered public land mobile network (RPLMN), an equivalent public land mobile network (EPLMN), or an operator public land mobile network (OPLMN).

4. The electronic device of claim 3, wherein the instructions, when executed by the at least one processor individually or collectively, further cause the electronic device to, as at least part of selecting the PLMN from the at least one PLMN supporting the normal service as the first PLMN:
identify a user command for causing selection of the one PLMN from the at least one PLMN supporting the normal service as the first PLMN, and
based on the user command, select the one PLMN from the at least one PLMN supporting the normal service as the first PLMN.

5. The electronic device of claim 3, wherein the instructions, when executed by the at least one processor individually or collectively, further cause the electronic device to, as at least part of selecting the one PLMN from the at least one PLMN supporting the normal service as the first PLMN:
based on a priority of the at least one PLMN supporting the normal service, select the one PLMN from the at least one PLMN supporting the normal service as the first PLMN.

6. The electronic device of claim 2, wherein the instructions, when executed by the at least one processor individually or collectively, further cause the electronic device to, as at least part of selecting the first PLMN from the at least one PLMN of the terrestrial network based on the service supported by the non-terrestrial network:
based on the non-terrestrial network supporting a text message service and not supporting a call service, select one PLMN from at least one PLMN supporting a normal service or a limited service as the first PLMN,
wherein the at least one PLMN supporting the normal service comprises at least one of a home public land mobile network (HPLMN), an equivalent home public land mobile network (EHPLMN), a registered public land mobile network (RPLMN), an equivalent public land mobile network (EPLMN), or an operator public land mobile network (OPLMN), and
wherein the at least one PLMN supporting the limited service comprises a visited home public land mobile network (VPLMN).

7. The electronic device of claim 6, wherein the instructions, when executed by the at least one processor individually or collectively, further cause the electronic device to, as at least part of selecting the one PLMN from the at least one PLMN supporting the normal service or the limited service as the first PLMN:
based on identifying the at least one PLMN supporting the normal service and the at least one PLMN supporting the limited service, select the one PLMN from the at least one PLMN supporting the normal service as the first PLMN.

8. The electronic device of claim 6, wherein the instructions, when executed by the at least one processor individually or collectively, cause the electronic device to, as at least part of selecting the one PLMN from the at least one PLMN supporting the normal service as the first PLMN based on identifying the at least one PLMN supporting the normal service or the limited service:
identify a user command for causing selection of the one PLMN from the at least one PLMN supporting the normal service as the first PLMN, and
based on the user command, select the one PLMN from the at least one PLMN supporting the normal service as the first PLMN.

9. The electronic device of claim 6, wherein the instructions, when executed by the at least one processor individually or collectively, further cause the electronic device to, as at least part of selecting the one PLMN from the at least one PLMN supporting the normal service as the first PLMN based on identifying the at least one PLMN supporting the normal service or the limited service:
based on a priority of the at least one PLMN supporting the normal service, select the one PLMN from the at least one PLMN supporting the normal service as the first PLMN.

10. The electronic device of claim 6, wherein the instructions, when executed by the at least one processor individually or collectively, further cause the electronic device to, as at least part of selecting the one PLMN from the at least one PLMN supporting the normal service or the limited service as the first PLMN based on the non-terrestrial network supporting the text message service and not supporting the call service:
based on identification of the at least one PLMN supporting the limited service and failure of identifying the at least one PLMN supporting the normal service, select the one PLMN from the at least one PLMN supporting the limited service as the first PLMN based on identifying a user command for causing an access to the one PLMN of the at least one PLMN supporting the limited service.

11. The electronic device of claim 1, wherein the instructions, when executed by the at least one processor individually or collectively, further cause the electronic device to, as at least part of identifying the satisfaction of the condition indicating that the non-terrestrial network is not used for at least the specified period:
identify a radio resource control (RRC) state of the non-terrestrial network being an RRC idle state, as the satisfaction of the condition.

12. The electronic device of claim 1, wherein the instructions, when executed by the at least one processor individually or collectively, further cause the electronic device to, as at least part of identifying the satisfaction of the condition indicating that the non-terrestrial network is not used for at least the specified period:
identify non-occurrence of a packet associated with the non-terrestrial network during at least than the specified period, as the satisfaction of the condition.

13. The electronic device of claim 1, wherein the instructions, when executed by the at least one processor individually or collectively, further cause the electronic device to:
based on failure of identifying the PLMN of the terrestrial network based on the search result for the PLMN of the terrestrial network, repeatedly perform the search for the PLMN of the terrestrial network periodically.

14. An operating method of an electronic device including at least one processor including processing circuitry and at least one communication module including communication circuitry, the operating method comprising:
accessing, by the at least one communication module, a non-terrestrial network;
identifying, by the at least one processor, satisfaction of a condition indicating that the non-terrestrial network is not used for at least a specified period of time, after the accessing the non-terrestrial network;
based on the satisfaction of the condition, requesting, by the at least one processor, a search for at least one public land mobile network (PLMN) of a terrestrial network from the at least one communication module;
providing, by the at least one communication module, the at least one processor with a search result for the at least one PLMN of the terrestrial network based on the requesting the search;
obtaining, by the at least one processor, the search result;
selecting, by the at least one processor, a first PLMN from the at least one PLMN of the terrestrial network identified based on the search result;
requesting, by the at least one processor, an access to the first PLMN from the at least one communication module; and
performing, by the at least one communication module, at least one operation for the access using a cell of the first PLMN, based on the requesting for the access to the first PLMN.

15. The operating method of claim 14, wherein the selecting the first PLMN from the at least one PLMN of the terrestrial network comprises:
selecting the first PLMN from the at least one PLMN of the terrestrial network based on a type of a service supported by the non-terrestrial network.

16. The operating method of claim 15, wherein the selecting the first PLMN from the at least one PLMN of the terrestrial network based on the service supported by the non-terrestrial network comprises:
based on the non-terrestrial network supporting a text message service and a call service, selecting one PLMN from at least one PLMN supporting a normal service as the first PLMN,
wherein the at least one PLMN supporting the normal service comprises at least one of a home public land mobile network (HPLMN), an equivalent home public land mobile network (EHPLMN), a registered public land mobile network (RPLMN), an equivalent public land mobile network (EPLMN), or an operator public land mobile network (OPLMN).

17. The operating method of claim 16, wherein the selecting the PLMN from the at least one PLMN supporting the normal service as the first PLMN comprises:
identifying a user command for causing selection of the one PLMN from the at least one PLMN supporting the normal service as the first PLMN; and
based on the user command, selecting the one PLMN from the at least one PLMN supporting the normal service as the first PLMN.

18. The operating method of claim 16, wherein selecting the one PLMN from the at least one PLMN supporting the normal service as the first PLMN comprises:
based on a priority of the at least one PLMN supporting the normal service, selecting the one PLMN from the at least one PLMN supporting the normal service as the first PLMN.

19. The operating method of claim 15, wherein the selecting the first PLMN from the at least one PLMN of the terrestrial network based on the service supported by the non-terrestrial network comprises:
based on the non-terrestrial network supporting a text message service and not supporting a call service, selecting one PLMN from at least one PLMN supporting a normal service or a limited service as the first PLMN,
wherein the at least one PLMN supporting the normal service comprises at least one of a home public land mobile network (HPLMN), an equivalent home public land mobile network (EHPLMN), a registered public land mobile network (RPLMN), an equivalent public land mobile network (EPLMN), or an operator public land mobile network (OPLMN), and
wherein the at least one PLMN supporting the limited service comprises a visited home public land mobile network (VPLMN).

20. A non-transitory computer-readable storage medium storing instructions that, when executed by at least one processor including processing circuitry of an electronic device, individually or collectively, cause the electronic device to:
identify satisfaction of a condition indicating that a non-terrestrial network is not used for at least a specified period of time, after the electronic device accesses the non-terrestrial network using at least one communication,
based on the satisfaction of the condition, obtain a search result for a public land mobile network (PLMN) of a terrestrial network,
select a first PLMN from at least one PLMN of the terrestrial network which is identified based on the search result for the PLMN of the terrestrial network, and
perform at least one operation for an access using a cell of the first PLMN.
